(19) United States
(12) Patent Application Publication
(10) Pub. No.: US 2012/0212616 A1
(43) Pub. Date: Aug. 23, 2012

(54) IMAGE CAPTURING DEVICE, ADJUSTING DEVICE, AND OPTICAL AXIS ADJUSTING SYSTEM FOR IMAGE CAPTURING DEVICE

(75) Inventors: Masayuki Usami, Nagoya-shi (JP); Shioya Kageyama, Toyota-shi (JP); Keigo Kojima, Okazaki-shi (JP)

(73) Assignee: TOYOTA JIDOSHA KABUSHIKI KAISHA, Toyota-shi, Aichi-ken (JP)

(21) Appl. No.: 13/505,184

(22) PCT Filed: May 13, 2010
(86) PCT No.: PCT/JP2010/003252

§ 371 Date: Apr. 30, 2012

(30) Foreign Application Priority Data
Nov. 4, 2009 (JP) PCT/JP2009/005858

(51) Int. Cl. H04N 7/18

(52) U.S. Cl. 348/148; 348/E07.085

(57) ABSTRACT

Provided is an image capturing device.

The image capturing device includes: a parameter setting section that automatically sets, (A) during ordinary times, a setting parameter for image-capturing to a value that depends on brightness of an image-capturing environment, and that sets, (B) at a time of the adjusting of the optical axis, the setting parameter to a predetermined adjustment setting value; a setting value receiving section that receives the adjustment setting value from the adjusting device when the adjusting of the optical axis is initiated; and an optical axis adjusting section that adjusts the optical axis based on an image captured in a state where the setting parameter is set to be the adjustment setting value. The adjusting device includes: a setting value storing section that stores the adjustment setting value in advance; and a setting value transmitting section that transmits the adjustment setting value to the image capturing device.

### TECHNICAL FIELD

The present invention relates to an image capturing device, an adjusting device, and an optical axis adjusting system for the image capturing device; and more specifically, relates to an image capturing device, an adjusting device, and an optical axis adjusting system for the image capturing device for adjusting an optical axis based on a captured image of a target.

### BACKGROUND ART

In recent years, there are vehicles having mounted thereon cameras for acquiring images of the peripheries of the vehicles. The cameras are mounted for acquiring images of the forward direction of the vehicles so as to be used, for example, for traffic lane recognition, preceding vehicle recognition, and the like. When attaching such a camera to a vehicle, misalignment of an optical axis direction occurs with respect to the traveling direction of the vehicle when attaching the camera due to mechanical factors and control-technological factors. A misalignment in the optical axis direction of the camera can lead to cases where a desired image cannot be obtained due to shifting in focus or not being able to capture a desired range for image-capturing. Therefore, an optical axis adjustment of a mounted camera is performed for every vehicle at a manufacturing plant of the vehicle, at a dealer, and the like. Known methods for adjusting the optical axis include, for example, a method disclosed in Patent Literature I of capturing, with a camera, an image of a target whose positional relationship with the vehicle has been established in advance. In the optical axis adjusting method disclosed in Patent Literature 1, a target having a white part and a black part is captured as an image by a camera, and an optical axis is adjusted by matching the center of the optical axis of the camera to the center of the target defined by a boundary line between the white part and the black part.

### CITATION LIST

### Patent Literature

[PTL 1] Japanese Laid-Open Patent Publication No. 2005-143040

### SUMMARY OF THE INVENTION

### Problems to be Solved by the Invention

However, the above described optical axis adjusting method has the following problem. When capturing an image, in order to capture a fine image, the camera mounted on the vehicle generally automatically adjusts exposure such as a gain, an electronic shutter, and the like in accordance with an image-capturing environment of whether it is in a bright location or a dark location and the like. On the other hand, the image-capturing environments in different factories or the like where the optical axis adjustments of the cameras are conducted are not uniform. Therefore, when the optical axis adjustment of the camera is conducted, the camera performs an exposure control in accordance with an image-capturing environment at one of such factories.

For example, when the background of a target is dark, the camera performs the exposure control so as to brighten the background of the target. In such a case, the white part of the target becomes saturated (i.e., halation occurs), and an area of the white part in an image may be captured as being larger than the actual area. When this happens, the boundary line between the white part and the black part cannot be detected accurately, and the center position of the target may be detected inaccurately. When the optical axis adjustment is conducted so as to match the optical axis to the inaccurately detected center position of the target, the optical axis may not be adjusted to an accurate position.

The present invention has been made in view of the above described problem, and an objective of the present invention is to provide an image capturing device and an optical axis adjusting system for the image capturing device enabling an accurate optical axis adjustment.

### Solution to the Problems

In order to solve the above described problem, the following configuration is employed in the present application. That is, a first aspect of the present invention is an optical axis adjusting system for adjusting an optical axis of an image capturing device mounted on a vehicle that captures an image of a periphery of the vehicle. The optical axis adjusting system for the image capturing device includes the image capturing device and an adjusting device communicably connected to the image capturing device. The image capturing device includes: a parameter setting section configured to, (A) during ordinary times, set a setting parameter for image-capturing to a value that depends on a brightness of an image-capturing environment, and, (B) at a time of the adjusting of the optical axis, set the setting parameter to a predetermined adjustment setting value; a setting value receiving section configured to receive the adjustment setting value from the adjusting device when the adjusting of the optical axis is initiated; and an optical axis adjusting section configured to adjust the optical axis based on an image captured in a state where the setting parameter is set to be the adjustment setting value. The adjusting device includes: a setting value storing section configured to store the adjustment setting value in advance; and a setting value transmitting section configured to transmit the adjustment setting value to the image capturing device.

In a second aspect based on the first aspect, the adjusting device further includes an input section configured to accept an input operation by a user, and a setting value changing section configured to change the adjustment setting value stored in the setting value storing section, in accordance with the input operation by the user.

In a third aspect based on the second aspect, the image capturing device further includes: an adjustment result determining section configured to determine, after the adjusting of the optical axis, whether or not the adjusting of the optical axis has been conducted properly; an image brightness calculating section configured to, when it has been determined that the adjusting of the optical axis has not been conducted properly, calculate an image brightness indicating a brightness of an image captured at a time of the adjusting of the optical axis; and an image brightness transmitting section configured to transmit the image brightness to the adjusting device. In addition, the adjusting device further includes: an image brightness receiving section configured to receive the image brightness; and a display section configured to display the image brightness.

In a fourth aspect based on the third aspect, the image brightness calculating section calculates an average luminance value of the image captured at the time of the adjusting of the optical axis, and calculates the image brightness as a value in accordance with the average luminance value.

In a fifth aspect based on the third aspect, the optical axis adjusting section adjusts the optical axis based on a captured image of a target arranged in a forward direction of the image capturing device in a state where the setting parameter is set to be the adjustment setting value, and the image brightness calculating section calculates an average luminance value of an image area representing the target within the image captured at the time of the adjusting of the optical axis, and calculates the image brightness as a value in accordance with the average luminance value.

In a sixth aspect based on the first aspect, the setting parameter at least includes an exposure time for the image capturing device.

In a seventh aspect based on the first aspect, the setting parameter includes an aperture value for an aperture member that limits an incident light volume of the image capturing device.

In an eighth aspect based on the first aspect, the optical axis adjusting section adjusts the optical axis based on a captured image of a target arranged in a forward direction of the image capturing device in a state where the setting parameter is set to be the adjustment setting value.

A ninth aspect is an image capturing device mounted on a vehicle and included in an optical axis adjusting system for adjusting an optical axis of the image capturing device that captures an image of a periphery of the vehicle. The image capturing device includes: a parameter setting section configured to, (A) during ordinary times, set a setting parameter for image-capturing to a value that depends on a brightness of an image-capturing environment, and, (B) at a time of the adjusting of the optical axis, set the setting parameter to a predetermined adjustment setting value; and an optical axis adjusting section configured to adjust the optical axis based on an image captured in a state where the setting parameter is set to be the adjustment setting value.

A tenth aspect is an adjusting device included in an optical axis adjusting system for adjusting an optical axis of an image capturing device that is mounted on a vehicle and that captures an image of a periphery of the vehicle. The adjusting device includes: a setting value storing section configured to store, in advance, an adjustment setting value that is used as a value of a setting parameter for image-capturing when the adjusting the optical axis of the image capturing device is conducted; and a setting value transmitting section configured to transmit the adjustment setting value to the image capturing device.

An eleventh aspect is an image capturing device that is mounted on a vehicle and that is for capturing an image of a periphery of the vehicle. The image capturing device includes: a parameter setting section configured to, (A) during ordinary times, automatically set a setting parameter for image-capturing to a value that depends on a brightness of an image-capturing environment, and, (B) at a time of adjusting an optical axis, set the setting parameter to a predetermined adjustment setting value; and an optical axis adjusting section configured to adjust the optical axis based on an image captured in a state where the setting parameter is set to be the adjustment setting value.

### Advantageous Effects of the Invention

With the first aspect of the present invention, the optical axis of the image capturing device can be adjusted accurately. Specifically, when adjusting the optical axis of the image capturing device, the setting parameter for image-capturing is fixed to an adjustment setting value. Therefore, the setting parameter for image-capturing will not be changed in accordance with the brightness of the surrounding environment, and thereby, will not be influenced by the surrounding environment. As a result, for example, an image of an object that is used as a standard target for an optical axis adjustment can be captured clearly. Consequently, the optical axis can be adjusted accurately based on the image that has been captured clearly

With the second aspect of the present invention, the adjustment setting value can be changed as appropriate to an arbitrary value set by the user. For example, one envisioned situation is a case where multiple image capturing devices are continuously or simultaneously adjusted at a manufacturing plant or the like. In this case, the multiple image capturing devices each can acquire adjustment setting values from the identical adjusting device. Therefore, when the user once changes the adjustment setting value by using the adjusting device, the adjustment setting values used by each of the image capturing devices at the time of adjusting can be changed all at once. As a result, the user can change the adjustment setting values used by each of the multiple image capturing devices at the time of adjusting, with a small number of operation steps.

With the third aspect of the present invention, the user can confirm the brightness (image brightness) of the image captured at the time of the optical axis adjustment. Therefore, the user can change the setting parameter for image-capturing in accordance with the image brightness. For example, when the image brightness is relatively high and when it is thought that halation can easily occur, the user can change the adjustment setting value so as to lower the brightness of the captured image.

With the fourth aspect of the present invention, the image brightness can be calculated using a simple process.

With the fifth aspect of the present invention, the brightness of the target in the captured image is displayed as the image brightness. Therefore, the user can confirm a numerical value of the image brightness and then can determine whether or not the brightness of the target in the captured image is at an easily recognizable level.

With the sixth aspect of the present invention, the exposure time of the image capturing device can be set to be the adjustment setting value at the time of the optical axis adjustment. As a result, at the time of the optical axis adjustment, the brightness of the image captured by the image capturing device can be arbitrarily and easily adjusted.

With the seventh aspect of the present invention, the aperture value of the aperture member included in the image capturing device can be set to be the adjustment setting value at the time of the optical axis adjustment. As a result, at the time of the optical axis adjustment, the brightness of the image captured by the image capturing device can be arbitrarily and easily adjusted.

With the eighth aspect of the present invention, the optical axis of the image capturing device can be adjusted using a simple process, based on the position of the target in the image captured by the image capturing device.

With the image capturing device according to the ninth aspect of the present invention and the adjusting device according to the tenth aspect, the optical axis adjusting system according to the first aspect can be formed, and thereby an advantageous effect identical to the optical axis adjusting system can be obtained.

With the adjusting device according to the eleventh aspect of the present invention, the setting parameter can be changed without communicating with another instrument, and the optical axis of the image capturing device can be adjusted accurately.

### BRIEF DESCRIPTION OF THE DRAWINGS

FIG. 1 is a block diagram showing a configuration of an optical axis adjusting system 1 according to a first embodiment.

FIG. 2 is a side view of a vehicle 30 arranged at a vehicle original position.

FIG. 3 is a front view of a target 50.

FIG. 4 is a flowchart showing processes executed by a camera-control ECU 12 and an equipment computer 21 according to the first embodiment.

FIG. 5 shows the rest of the flowchart showing the processes executed by the camera-control ECU 12 and the equipment computer 21 according to the first embodiment.

FIG. 6 shows one example of an abnormality screen displayed on a display 22 when an optical axis adjustment has been terminated due to an abnormality.

FIG. 7 is a block diagram showing a configuration of an image capturing device 40 according to a second embodiment.

FIG. 8 is a flowchart showing processes executed by a camera-control ECU 61 according to the second embodiment.

### DESCRIPTION OF EMBODIMENTS

First Embodiment

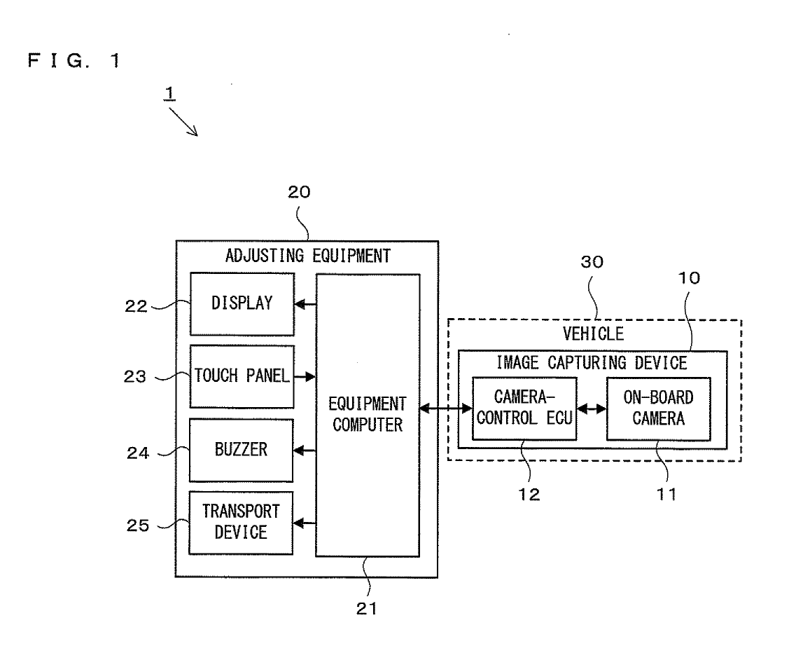

Descriptions are provided in the following with reference to FIG. 1 to FIG. 6 for an image capturing device 10 and an optical axis adjusting system 1 of the image capturing device according to the first embodiment of the present invention.

First, with reference to FIG. 1, a configuration of the optical axis adjusting system 1 will be described. FIG. 1 is a block diagram showing the configuration of the optical axis adjusting system 1 according to the first embodiment. As shown in FIG. 1, the optical axis adjusting system 1 includes an image capturing device 10 and adjusting equipment 20. The image capturing device 10 includes an on-board camera 11 and a camera-control ECU 12. In addition, the adjusting equipment 20 includes an equipment computer 21, a liquid crystal display 22, a touch panel 23, a buzzer 24, and a transport device 25. Described in the following is an example in which the image capturing device 10 is mounted on a vehicle 30.

The on-board camera 11 is, for example, a camera including a lens and an image sensor such as a CCD (Charge Coupled Device) sensor, a CMOS (Complementary Metal Oxide Semiconductor) sensor, and the like. The on-board camera 11 is communicably connected to the camera-control ECU 12, and changes settings for image-capturing in response to instructions from the camera-control ECU 12. Specifically, the on-board camera 11 changes a value of an exposure time T in response to an instruction from the camera-control ECU 12. The exposure time T is the time period the image sensor is exposed when the on-board camera 11 captures an image. In addition, the on-board camera 11 outputs data representing a captured image to the camera-control ECU 12. It should be noted that, in the following, an image captured by the on-board camera 11 is referred to as a camera image.

Representatively, the camera-control ECU 12 is a control device including an information processing device such as a CPU (Central Processing Unit), a storage device such as a memory, an interface circuit, and the like. The camera-control ECU 12 is communicably connected to the equipment computer 21, and executes an optical axis adjustment of the on-board camera 11 in accordance with an instruction signal and data received from the equipment computer 21. The camera-control ECU 12 and the equipment computer 21 may be mutually connected with a communication method of either a wireless communication or a wired communication. Details of processes for the camera-control ECU 12 will be described later.

Representatively, the equipment computer 21 is a control device including an information processing device such as a CPU (Central Processing Unit), a storage device such as a memory, an interface circuit, and the like. The equipment computer 21 operates the liquid crystal display 22, the buzzer 24, and the transport device 25, in accordance with an input operation by the user via the touch panel 23, and a signal received from the camera-control ECU 12, and the like.

Representatively, the display 22 is a display device capable of displaying an image, such as a liquid crystal display. The display 22 displays various information and button images for operating the adjusting equipment 20 in response to an instruction from the equipment computer 21.

The touch panel 23 is an input device for accepting an input operation on the equipment computer 21 by the user. The touch panel 23 is arranged so as to cover a screen of the display 22 and to allow display contents on the screen to pass through. The user performs a touch input on a button displayed on the screen of the display 22 via the touch panel 23, and causes the equipment computer 21 to execute an operation corresponding to the button. It should be noted that various types of touch panels may be used as the touch panel 23, including an electrostatic type, a pressure-sensitive type, an infrared sensing type, and the like.

The buzzer 24 is an audio output device for generating a warning sound. The buzzer 24 is connected to the equipment computer 21. The buzzer 24 generates a warning sound in response to an instruction from the equipment computer 21.

The transport device 25 is a device for transporting the vehicle 30 to a predetermined position (hereinafter, referred to as a vehicle original position) for executing the optical axis adjustment. The transport device 25 is connected to the equipment computer 21. The transport device 25 transports the vehicle 30 into the vehicle original position and transports the vehicle 30 out from the vehicle original position in response to an instruction from the equipment computer 21. In addition, when the vehicle 30 is transported into the vehicle original position, the transport device 25 outputs, to the equipment computer 21, an arrangement completion signal indicating that the vehicle 30 has been arranged at the vehicle original position.

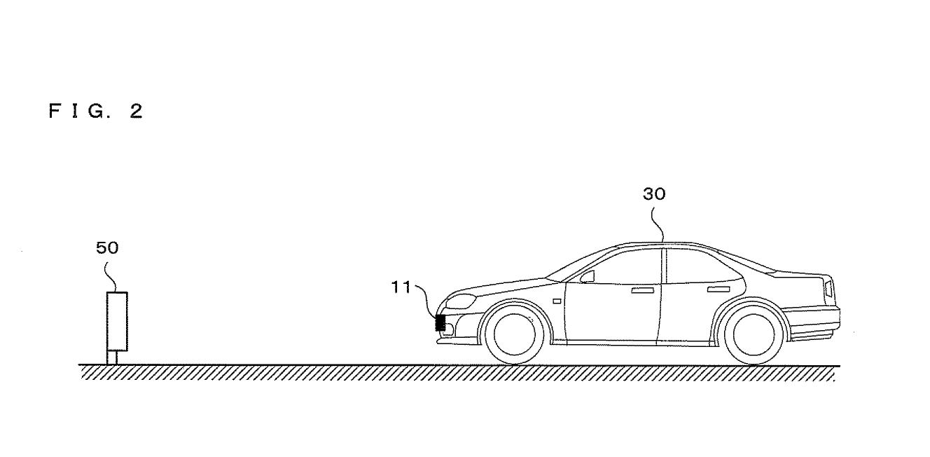

FIG. 2 is a side view of the vehicle 30 arranged at the vehicle original position by the transport device 25. As shown in FIG. 2, the vehicle 30 is arranged at the vehicle original position such that the on-board camera 11 and a target 50 face each other. It should be noted that the mounted position of the on-board camera 11 is one example. The on-board camera 11 may be mounted at any position of the vehicle 30 as long as it is arranged so as to face the target 50 at the vehicle original position.

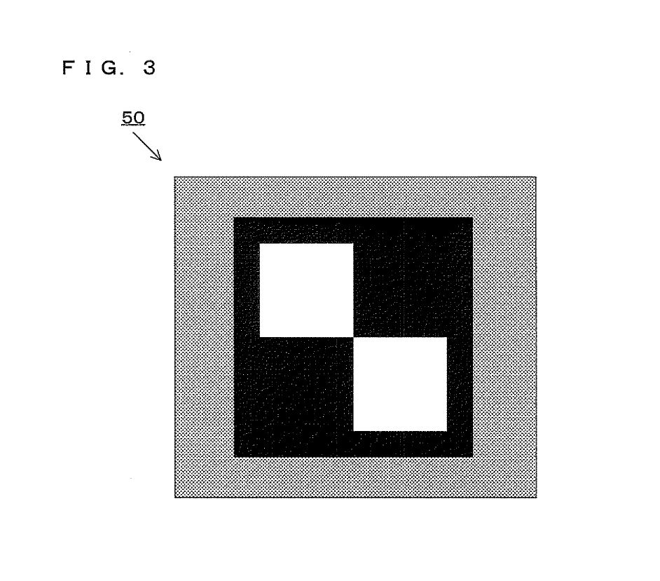

FIG. 3 is a front view of the target 50. The target 50 according to the present embodiment is a plate-like member as shown in FIG. 2 and FIG. 3. A lattice pattern in which white and black areas are alternately arranged is drawn on a plate surface of the target 50. It should be noted that the above described shape and pattern of the target 50 are those of one example, and an object having any shape and pattern may be used as the target as long as it is an object that can be captured as an image by the on-board camera 11 as a standard for axis adjustment.

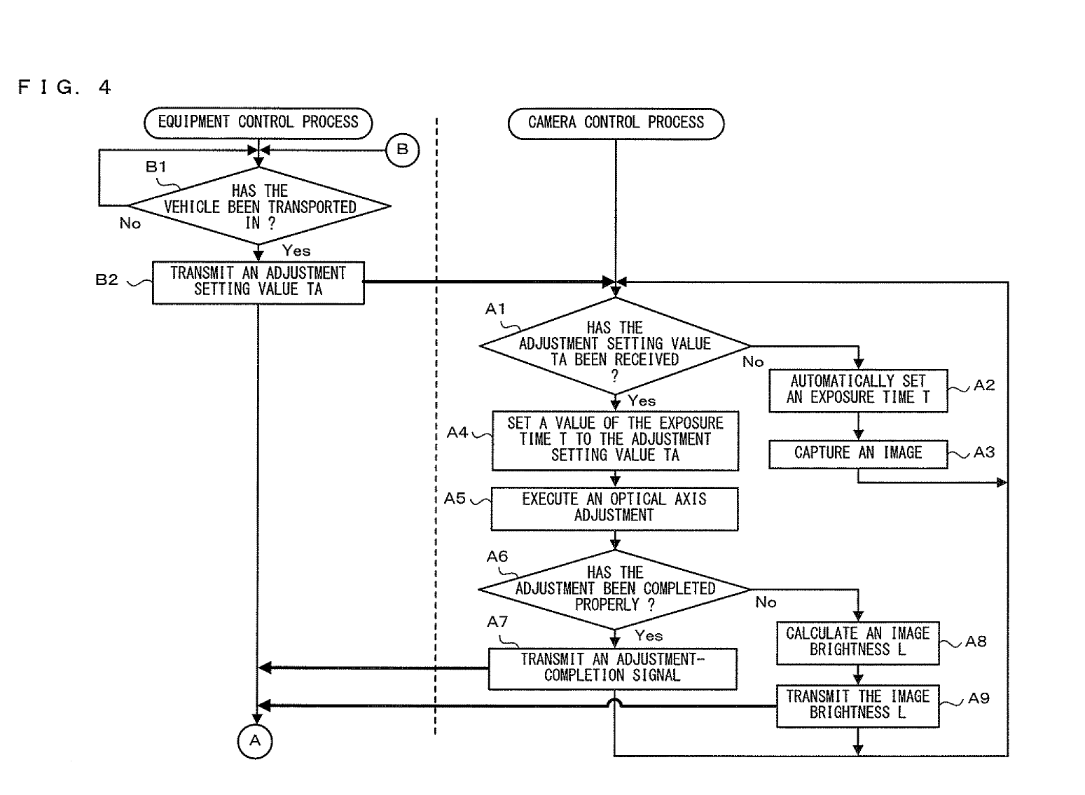

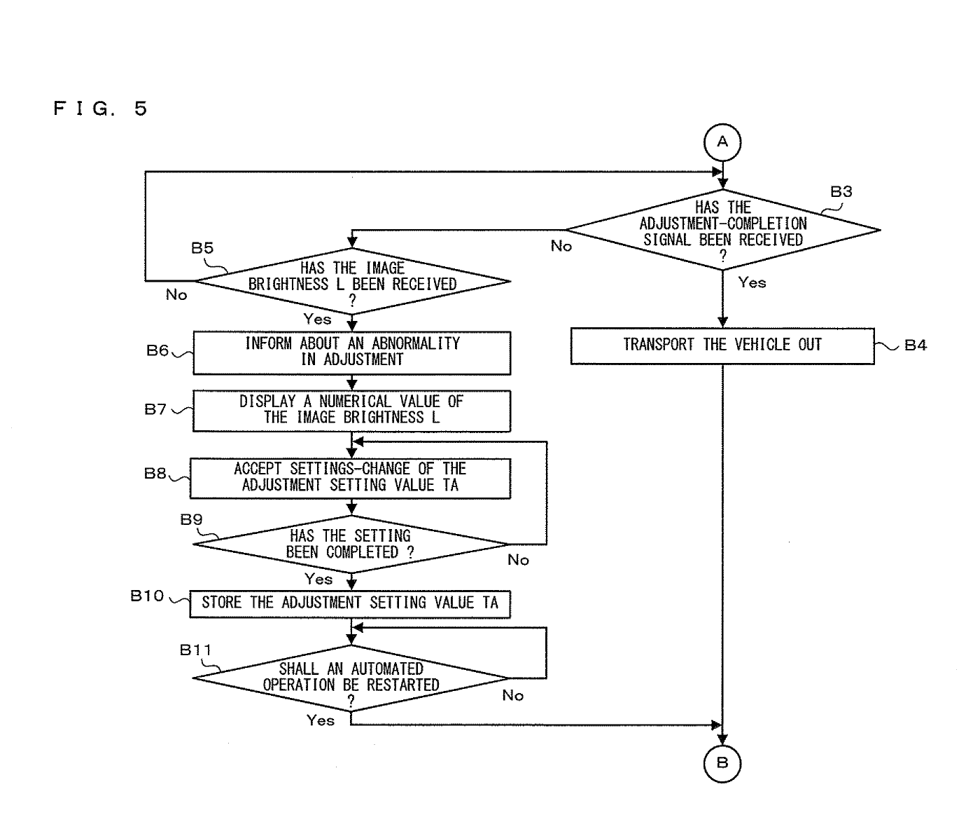

Next, with reference to FIG. 4 and FIG. 5, processes executed by the camera-control ECU 12 and the equipment computer 21 will be described. FIG. 4 and FIG. 5 show a flowchart indicating the processes executed by the camera-control ECU 12 and the equipment computer 21 according to the first embodiment. The camera-control ECU 12 executes a camera control process shown in FIG. 4. Furthermore, the equipment computer 21 executes an equipment control process shown in FIG. 4 and FIG. 5.

When the equipment computer 21 initiates the equipment control process shown in FIG. 4, first, the equipment computer 21 determines whether or not the vehicle 30 has been transported into the vehicle original position (step B1). Specifically, the equipment computer 21 determines whether or not the arrangement completion signal has been received from the transport device 25. When the equipment computer 21 has not received the arrangement completion signal from the transport device 25, the equipment computer 21 determines that the vehicle 30 has not been transported into the vehicle original position (“No” at step B1), and waits until the arrangement completion signal is received. While the equipment computer 21 is waiting, the transport device 25 transports the vehicle 30 into the vehicle original position. On the other hand, when the equipment computer 21 receives the arrangement completion signal from the transport device 25, the equipment computer 21 determines that the vehicle 30 has been transported into the vehicle original position (“Yes” at step B1), and transmits an adjustment setting value TA to the camera-control ECU 12 (step B2).

When the camera-control ECU 12 initiates the camera control process shown in FIG. 4, first, the camera-control ECU 12 determines whether or not the adjustment setting value TA has been received from the equipment computer 21 (step A1). When the camera-control ECU 12 has not received the adjustment setting value TA (“No” at step A1), the camera-control ECU 12 conducts an ordinary image capturing process (from step A2 to step A3). Specifically, first, the camera-control ECU 12 automatically sets the exposure time T (step A2). In more detail, the camera-control ECU 12 acquires a camera image captured by the on-board camera 11. Then, the camera-control ECU 12 calculates an average luminance value of the camera image, and sets the exposure time T shorter as the average luminance value becomes larger, and sets the exposure time TA longer as the average luminance value becomes smaller. Next, the camera-control ECU 12 causes the on-board camera 11 to capture a camera image, and acquires the camera image (step A3). Additionally at step A3, the camera-control ECU 12 transmits data of the acquired camera image to an instrument (not shown) that conducts controls using the image data. When the process at step A3 is completed, the camera-control ECU 12 returns the process to step A1, and repeatedly executes the above described processes at step A2 and step A3 until the adjustment setting value TA is received.

With the above described processes from step Al to step A3, when the optical axis adjustment has not been conducted, the exposure time T is automatically set in accordance with the brightness of an image-capturing environment.

On the other hand, when the camera-control ECU 12 receives the adjustment setting value TA (“Yes” at step A1), the camera-control ECU 12 conducts a control process for the optical axis adjustment (from step A4 to step A9). First, the camera-control ECU 12 sets the value of the exposure time T to the adjustment setting value TA (step A4). Next, the camera-control ECU 12 executes the optical axis adjustment for the on-board camera 11 (step AS). Specifically, the camera-control ECU 12 acquires a camera image from the on-board camera 11, and detects a central point of the target 50 in the camera image. Then, the optical axis of the on-board camera 11 is adjusted by shifting an image-capturing range of the camera image such that the central point is positioned within a predetermined area of the camera image (hereinafter, referred to as a target acquisition area). It should be noted that the above described method for optical axis adjustment is one example, and the optical axis of the on-board camera 11 may be adjusted using a conventionally known method, as long as the camera-control ECU 12 conducts the optical axis adjustment based on the camera image.

With the above described processes at step A4 and step AS, when conducting the optical axis adjustment, the exposure time T is fixed to the adjustment setting value TA. As a result, the camera-control ECU 12 can execute the optical axis adjustment without being influenced by the brightness of the image-capturing environment.

When the camera-control ECU 12 completes the process at step A5, the camera-control ECU 12 determines whether or not the axis adjustment has been completed properly (step A6). For example, the camera-control ECU 12 acquires a camera image from the on-board camera 11, and determines whether or not the center of the target 50 is captured in the target acquisition area of the camera image. Then, when the center of the target 50 is captured in the target acquisition area of the camera image, the camera-control ECU 12 determines that the axis adjustment has been completed properly (“Yes” at step A6), and transmits an adjustment-completion signal to the equipment computer 21 (step A7). The adjustment-completion signal is a signal indicating that the optical axis adjustment of the on-board camera 11 has been completed properly. On the other hand, when the center of the target 50 is not captured in the target acquisition area of the camera image, the camera-control ECU 12 determines that the axis adjustment has not been completed properly (“No” at step A6), and calculates an image brightness L (step A8). The image brightness L is a parameter indicating the brightness of the camera image. The camera-control ECU 12 detects, for example, the target 50 in the camera image acquired at step A6. Then, the camera-control ECU 12 calculates, as the image brightness L, an average luminance value of an area representing the target 50 in the camera image. When the camera-control ECU 12 calculates the image brightness L, the camera-control ECU 12 transmits data representing the image brightness L to the equipment computer 21.

It should be noted that the above described method shown at step A6 is one example, and the camera-control ECU 12 may determine whether or not the optical axis adjustment has been completed properly by using any conventionally known method.

After the equipment computer 21 executes a process for transmitting the adjustment setting value TA (step B2), the equipment computer 21 determines whether or not the adjustment-completion signal or the image brightness L has been received (step B3 and step B5). More specifically, when the adjustment-completion signal has not been received (“No” at step B3), the equipment computer 21 determines whether or not the image brightness L has been received (step B5). If the equipment computer 21 has not received the adjustment-completion signal or the image brightness L (“No” at step B3, and “No” at step B5), the equipment computer 21 waits until either the adjustment-completion signal or the image brightness L is received. When the equipment computer 21 receives the adjustment-completion signal (“Yes” at step B3), the equipment computer 21 operates the transport device 25 and transports the vehicle 30 out from vehicle original position (step B4). On the other hand, when the equipment computer 21 has not received the adjustment-completion signal but receives the image brightness L (“No” at step 133 and “Yes” at step B5), the equipment computer 21 executes a process to deal with an abnormality during adjustment (from step B6 to step B11).

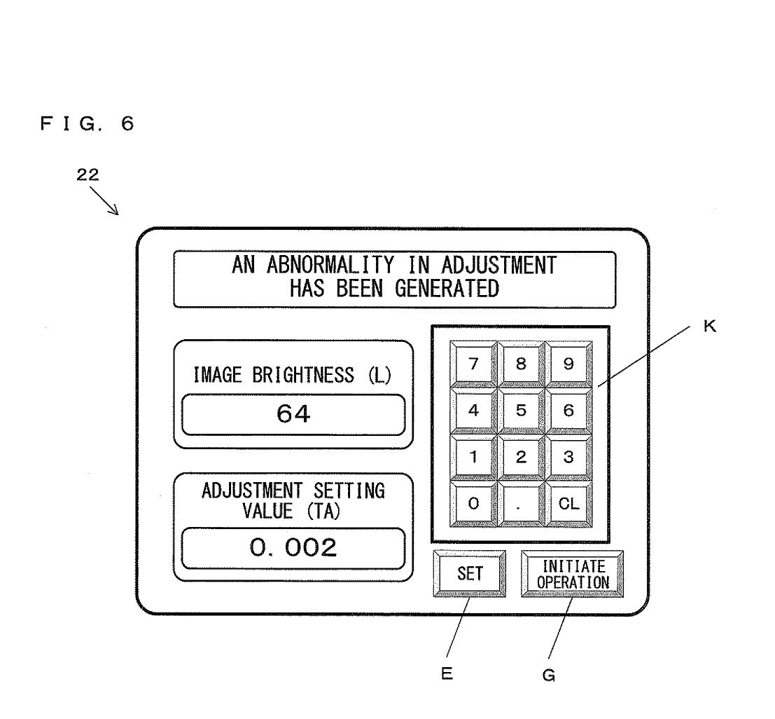

First, the equipment computer 21 informs the user that the optical axis adjustment of the on-board camera 11 has been terminated due to an abnormality (step B6). Specifically, the equipment computer 21 outputs a warning sound from the buzzer 24. In addition, the equipment computer 21 causes the display 22 to display an image indicating that the adjustment has not been completed. For example, the equipment computer 21 displays an abnormality screen on the display 22 as shown in FIG. 6. FIG. 6 shows one example of the abnormality screen displayed on the display 22 when the optical axis adjustment is terminated due to an abnormality. In addition, the equipment computer 21 displays, on the display 22, the value of the image brightness L received from the camera-control ECU 12 (step B7).

Furthermore, the equipment computer 21 accepts, on the abnormality screen, an operation for changing the setting of the adjustment setting value TA by the user (step B8). Specifically, the equipment computer 21 displays on the display 22 a button image for numerical inputs, such as a numerical keypad image K (cf. FIG. 6). Then, by detecting a touch input to the numerical keypad image K using the touch panel 23, the equipment computer 21 accepts a numerical input from the user. While accepting a setting for the adjustment setting value TA, the equipment computer 21 determines whether or not the setting has been completed (step B9). Specifically, the equipment computer 21 determines whether or not a touch input on a setting button E on the abnormality screen shown in FIG. 6 has been detected. When the equipment computer 21 has not detected the touch input to the setting button E, the equipment computer 21 determines that the setting of the adjustment setting value TA has not been completed (“No” at step B9), and waits until the touch input to the setting button E is detected. On the other hand, when the equipment computer 21 detects the touch input to the setting button E, the equipment computer 21 determines that the setting of the adjustment setting value TA has been completed (“Yes” at step 89), and stores, in a storage device of the equipment computer 21, the above described numerical value accepted at step B8 as a value of the adjustment setting value TA (step B10).

With the above described processes from step B5 to step B10, the user can set the adjustment setting value TA to an arbitrary value while referring to the value of the image brightness L, since the value of the image brightness L is displayed on the abnormality screen. For example, when the image brightness is relatively high and when it is thought that halation can easily occur, the user can change the adjustment setting value so as to lower the brightness of the captured image.

Furthermore, with the above described process at step A8, since the brightness of the target 50 in the camera image is calculated as the image brightness L, the user can confirm the image brightness L and can determine whether or not the target 50 in the camera image is captured with brightness at an easily recognizable level. When there is a desire to confirm the brightness of the whole camera image instead of only the brightness of the target 50, the camera-control ECU 12 may, for example, calculate an average luminance value of the whole camera image as the image brightness L at step A8.

When the equipment computer 21 completes the process at step B10, the equipment computer 21 determines whether or not restarting of an automated operation has been instructed by the user (step B11). The equipment computer 21 determines whether or not a touch input to an operation-start button G has been detected on the abnormality screen shown in FIG. 6. When the equipment computer 21 has not detected the touch input to the operation-start button G, the equipment computer 21 determines that restarting of the automated operation has not been instructed (“No” at step B11), and waits until the touch input to the operation-start button G is detected. On the other hand, when the equipment computer 21 detects a touch input to the operation-start button G, the equipment computer 21 determines that setting of the adjustment setting value TA has been completed (“Yes” at step B11), returns the process to step B1, and repeatedly executes the above described processes from step B1 to step B11.

By having the equipment computer 21 and the camera-control ECU 12 repeat the above described processes, the optical axis adjustment of the on-board camera 11 mounted on the vehicle can be executed continuously and automatically.

As described above, with the optical axis adjusting system 1 according to the present invention, when adjusting the optical axis of the on-board camera 11, adjustment of the optical axis is executed by fixing the value of the exposure time T to the adjustment setting value TA. As a result, at the time of the optical axis adjustment, the on-board camera 11 can clearly capture an image of the target 50 without being influenced by the brightness of the surrounding environment. Then, since the optical axis of the on-board camera 11 is adjusted based on the camera image captured clearly, the adjustment of the optical axis can be executed accurately.

It should be noted that, in the above described first embodiment, an example has been described in which the equipment computer 21 and the camera-control ECU 12 set the exposure time T of the on-board camera 11 to the adjustment setting value TA at the time of the optical axis adjustment. However, the present invention is not limited to the exposure time T, and the equipment computer 21 and the camera-control ECU 12 may set other parameters involved in the brightness of the camera image. For example, when the on-board camera 11 includes an aperture member for automatically controlling an incident light volume, the equipment computer 21 and the camera-control ECU 12 may control an aperture value of the aperture member. Specifically, when adjusting the optical axis, the equipment computer 21 transmits a setting value SA for the aperture value for optical axis adjustment to the camera-control ECU 12. Then, the camera-control ECU 12 sets the aperture value to the received setting value SA and executes the optical axis adjustment. Similarly, the equipment computer 21 and the camera-control ECU 12 may control a gain value of the on-board camera 11.

Furthermore, in the first embodiment, an example has been described in which the touch panel 23 is included in the adjusting equipment 20 as a device for accepting an input operation by the user. However, the adjusting equipment 20 may include another input device instead of the touch panel 23. For example, the adjusting equipment 20 may be formed by substituting the touch panel 23 with an input device such as a mouse or a keyboard. Furthermore, when the vehicle 30 is transported by a person, it is possible to not include the transport device 25 in the adjusting equipment 20.

Furthermore, in the first embodiment, an example has been described in which the optical axis adjusting system 1 includes the image capturing device 10 and the adjusting equipment 20. However, the optical axis adjusting system 1 may be formed from a small size terminal device having the same functions as the image capturing device 10 and the adjusting equipment 20. For example, the optical axis adjusting system may be configured by communicably connecting, to the image capturing device 10, a laptop personal computer capable of conducting the same control process of the equipment computer 21. Such configuration is suitable when conducting the optical axis adjustment of the image capturing device 10 in an environment where arranging a large equipment is difficult, such as in a repair shop, for example.

Furthermore, in the first embodiment, an example has been described in which the equipment computer 21 stores the value of the adjustment setting value TA and transmits the adjustment setting value TA to the camera-control ECU 12 when executing the optical axis adjustment. However, the camera-control ECU 12 may store therein the value of the adjustment setting value TA in advance. Specifically, at the above described step B2, the equipment computer 21 only transmits, to the camera-control ECU 12, a signal indicating an instruction to initiate the adjustment. The camera-control ECU 12 determines at step Al whether or not the signal indicating the instruction to initiate the adjustment has been received. Then, when the camera-control ECU 12 determines that the signal indicating the instruction to initiate the adjustment has been received, the camera-control ECU 12 reads out at step B4 the value of the adjustment setting value TA stored in its own storage device, and sets the value of the exposure time T for the on-board camera 11 to the adjustment setting value TA. By having such a configuration and by conducting such processes, data volume transmitted from the equipment computer 21 to the camera-control ECU 12 and storage area necessary for the equipment computer 21 can be reduced.

Second Embodiment

In the first embodiment, an example has been described in which the adjustment setting value TA is stored and changed by the adjusting equipment 20. However, the value of the adjustment setting value TA may be stored and changeable by a device mounted on the vehicle 30. In the following, an image capturing device 40 according to a second embodiment will be described.

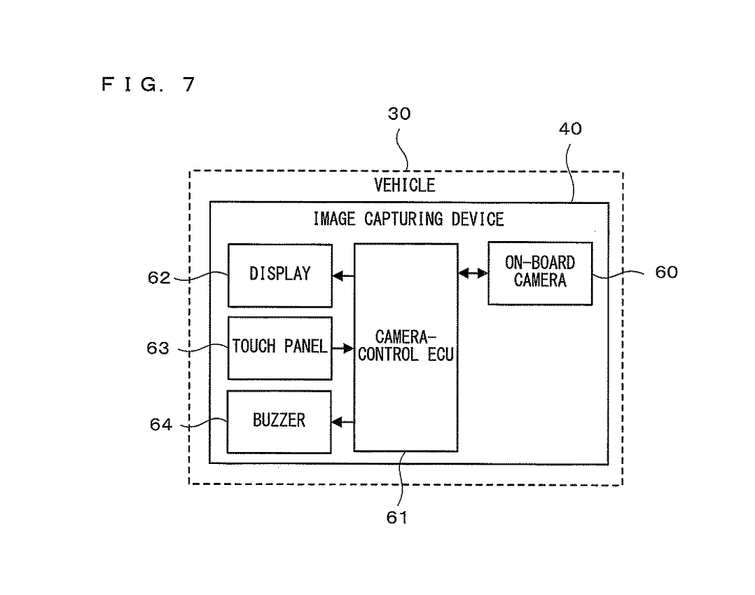

As shown in FIG. 7, the image capturing device 40 according to the second embodiment includes an on-board camera 60, a camera-control ECU 61, a display 62, a touch panel 63, and a buzzer 64. FIG. 7 is a block diagram showing a configuration of the image capturing device according to the second embodiment. It should be noted that the image capturing device 40 is mounted on the vehicle 30.

The on-board camera 60, the camera-control ECU 61, the display 62, the touch panel 63, and the buzzer 64 are devices similar to the display 22, the touch panel 23, and the buzzer 24 according to the first embodiment in terms of hardware. However, the camera-control ECU 61, the display 62, the touch panel 63, and the buzzer 64 are different from the display 22, the touch panel 23, and the buzzer 24 according to the first embodiment in terms of the following points.

First, the touch panel 63 and the buzzer 64 are each connected to the camera-control ECU 61 instead of the equipment computer 21. In addition, the display 62 displays various information and button images for setting the adjustment setting value TA in response to an instruction from the camera-control ECU 61. Furthermore, the touch panel 23 accepts an input operation on the camera-control ECU 61 by the user. Still further, the buzzer 24 generates a warning sound in response to an instruction from the camera-control ECU 61. The display 62 and the touch panel 63 are installed inside a cabin of the vehicle 30 at positions where the user can operate. For example, the display 62 and the touch panel 63 are mounted on an instrument panel of the vehicle 30.

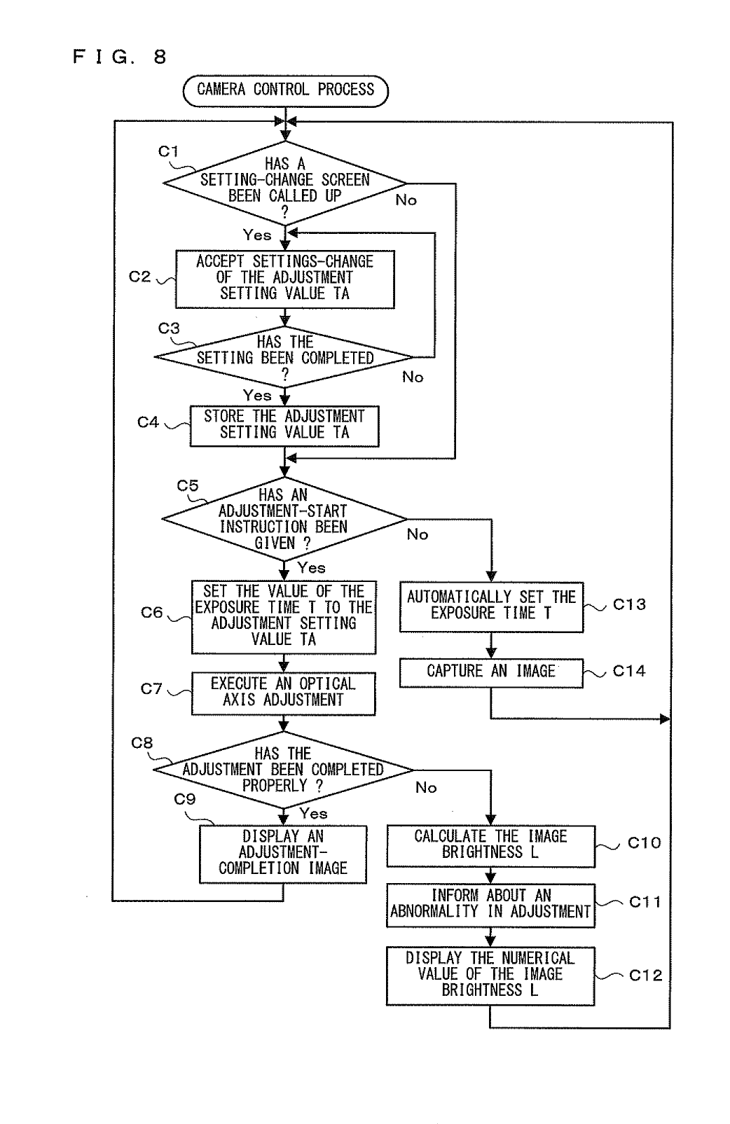

Furthermore, the camera-control ECU 61 according to the second embodiment executes processes that are partially different from those executed by the camera-control ECU 12 according to the first embodiment. Details of the processes executed by the camera-control ECU 61 will be described in the following with reference to FIG. 8. FIG. 8 is a flowchart showing the processes executed by the camera-control ECU 61 according to the second embodiment.

When the camera-control ECU 61 initiates a camera control process shown in FIG. 8, first, the camera-control ECU 61 determines whether or not a setting-change screen has been called up (step C1). Specifically, the camera-control ECU 61 displays on the display 62 a button (hereinafter, referred to as a change screen call-up button) to call up a screen for setting the adjustment setting value TA as shown in FIG. 6. Then, when a touch input to the change screen call-up button is detected (“Yes” at step C1), the camera-control ECU 61 accepts, in the same manner as step B8, setting change to the adjustment setting value TA (step C2). When the camera-control ECU 61 has not detected the touch input to the change screen call-up button (“No” at step C1), the camera-control ECU 61 advances the process to step C5. While accepting a setting change for the adjustment setting value TA, the camera-control ECU 61 determines, in the same manner as the above described step B9, whether or not the setting has been completed (step C3). Here, when the camera-control ECU 61 has not detected the touch input to the setting button E, the camera-control ECU 61 determines that the setting of the adjustment setting value TA has not been completed (“No” at step C3), and waits until the touch input to the setting button E is detected (return to step C2). On the other hand, when the camera-control ECU 61 detects the touch input to the setting button E, the camera-control ECU 61 determines that the setting of the adjustment setting value TA has been completed (“Yes” at step C3), and stores, in a storage device of the camera-control ECU 61, the above described numerical value accepted at step C3 as a value of the adjustment setting value TA (step C4). When the process at step C4 is completed, the camera-control ECU 61 advances the process to step C5.

At step C5, the camera-control ECU 61 determines whether or not the user has given an adjustment-start instruction (step C5). Specifically, the camera-control ECU 61 displays on the display 62 a button (hereinafter, referred to as an adjustment-start button) for giving an instruction to initiate the optical axis adjustment. Then, when a touch input to the adjustment-start button is detected (“Yes” at step C5), the camera-control ECU 61 initiates the optical axis adjustment. Specifically, the camera-control ECU 61 first sets, in the same manner as the above described step A4, the value of the exposure time T to the adjustment setting value TA (step C6). Next, similar to the above described step A5, the camera-control ECU 61 executes the optical axis adjustment (step C7). When the process at step C7 is completed, the camera-control ECU 61 determines, in the same manner as the above described step A6, whether or not the optical axis adjustment has been completed properly (step C8). Then, when the camera-control ECU 61 determines that the axis adjustment has been completed properly (“Yes” at step C8), the camera-control ECU 61 displays on the display 62 an image (hereinafter, referred to as an adjustment-completion image) indicating that the adjustment has been completed properly (step C9). After displaying the adjustment-completion image, the camera-control ECU 61 returns the process to step C1, and repeats the above described processes. On the other hand, when the camera-control ECU 61 determines that the axis adjustment has not been completed properly (“No” at step C8), the camera-control ECU 61 executes a process to deal with an abnormality during adjustment (from step CIO to step C 12).

First, the camera-control ECU 61 calculates the image brightness L in the same manner as the above described process at step A8 (step C 10). Next, the camera-control ECU 61 informs the user about an abnormality in the adjustment in the same manner as the above described process at step B6 (step C11). Then, the camera-control ECU 61 displays on the display 62 the value of the image brightness L calculated at step C10 (step C 12). When the process at step C 12 is completed, the camera-control ECU 61 returns the process to step C1, and repeats the above described processes.

On the other hand, when the touch input to the adjustment-start button has not been detected at step C5, the camera-control ECU 61 conducts an image capturing process (from step C13 to step C 14). Specifically, the camera-control ECU 61 automatically sets the exposure time T in the same manner as the above described step A2 (step C 13). Then, the camera-control ECU 61 captures an image in the same manner as the above described step A3 (step C14). When the process at step C14 is completed, the camera-control ECU 61 returns the process to step C1, and repeats the above described processes.

With the above described image capturing device 40 according to the second embodiment, at the time of the optical axis adjustment, the value of the exposure time T can be set to the adjustment setting value TA without having any communications between the image capturing device 40 and the adjusting equipment 20. Therefore, the optical axis adjustment can be executed accurately even in an environment where the adjusting equipment 20 does not exist.

It should be noted that the camera-control ECU 61 according to the second embodiment may be configured so as to be communicably with the equipment computer 21 according to the first embodiment. Then, when the camera-control ECU 61 receives the adjustment setting value TA from the equipment computer 21, the camera-control ECU 61 may execute the processes of the camera-control ECU 21 shown in FIG. 4.

### INDUSTRIAL APPLICABILITY

The image capturing device and the optical axis adjusting system for the image capturing device according to the present invention are respectively useful as an image capturing device and an optical axis adjusting system for the image capturing device enabling an accurate optical axis adjustment.

### DESCRIPTION OF THE REFERENCE CHARACTERS

1 optical axis adjusting system

10, 40 image capturing device

11, 60 on-board camera

12, 61 camera-control ECU

20 adjusting equipment

21 equipment computer

22, 62 display

23, 63 touch panel

24, 64 buzzer

25 transport device

30 vehicle

50 target

1. An image capturing device that is mounted on a vehicle and that is for capturing an image of a periphery of the vehicle, the image capturing device comprising:
a parameter setting section configured to, (A) during ordinary times, set a setting parameter for image-capturing to a value that depends on a brightness of an image-capturing environment, and, (B) at a time of adjusting an optical axis, set the setting parameter to a predetermined adjustment setting value; and
an optical axis adjusting section configured to adjust the optical axis based on an image captured in a state where the setting parameter is set to be the adjustment setting value.

2. The image capturing device according to claim 1, further comprising:
a setting value storing section configured to store the adjustment setting value in advance;
an input section configured to accept an input operation by a user; and
a setting value changing section configured to change the adjustment setting value stored in the setting value storing section, in accordance with the input operation by the user.

3. The image capturing device according to claim 2, further comprising:
an adjustment result determining section configured to determine, after the adjusting of the optical axis, whether the adjusting of the optical axis has been conducted properly;
an image brightness calculating section configured to calculate, when it has been determined that the adjusting of the optical axis has not been conducted properly, an image brightness indicating a brightness of an image captured at the time of the adjusting of the optical axis; and
a display section configured to display the image brightness.

4. The image capturing device according to claim 3, wherein the image brightness calculating section calculates an average luminance value of the image captured at the time of the adjusting of the optical axis, and calculates the image brightness as a value in accordance with the average luminance value.

5. The image capturing device according to claim 3, wherein:
the optical axis adjusting section adjusts the optical axis based on a captured image of a target arranged in a forward direction of the image capturing device in a state where the setting parameter is set to be the adjustment setting value; and
the image brightness calculating section calculates an average luminance value of an image area representing the target within the image captured at the time of the adjusting of the optical axis, and calculates the image brightness as a value in accordance with the average luminance value.

6. The image capturing device according to claim 1, wherein the setting parameter at least includes an exposure time for the image capturing device.

7. The image capturing device according to claim 1, wherein the setting parameter includes an aperture value for an aperture member that limits an incident light volume of the image capturing device.

8. The image capturing device according to claim 1, wherein the optical axis adjusting section adjusts the optical axis based on a captured image of a target arrange in a forward direction of the image capturing device in a state where the setting parameter is set to be the adjustment setting value.

9. An optical axis adjusting system for adjusting an optical axis of an image capturing device mounted on a vehicle that captures an image of a periphery of the vehicle, the optical axis adjusting system comprising:
the image capturing device; and
an adjusting device communicably connected to the image capturing device, wherein
the image capturing device includes:
a parameter setting section configured to, (A) during ordinary times, automatically set a setting parameter for image-capturing to a value that depends on a brightness of an image-capturing environment, and, (B) at a time of the adjusting of the optical axis, set the setting parameter to a predetermined adjustment setting value;
a setting value receiving section configured to receive the adjustment setting value from the adjusting device when the adjusting of the optical axis is initiated; and
an optical axis adjusting section configured to adjust the optical axis based on an image captured in a state where the setting parameter is set to be the adjustment setting value, and
the adjusting device includes:
a setting value storing section configured to store the adjustment setting value in advance; and
a setting value transmitting section configured to transmit the adjustment setting value to the image capturing device.

10. The optical axis adjusting system for the image capturing device according to claim 9, wherein
the adjusting device further includes:
an input section configured to accept an input operation by a user; and
a setting value changing section configured to change the adjustment setting value stored in the setting value storing section, in accordance with the input operation by the user.

11. The optical axis adjusting system for the image capturing device according to claim 10, wherein
the image capturing device further includes:
an adjustment result determining section configured to determine, after the adjusting of the optical axis, whether the adjusting of the optical axis has been conducted properly;
an image brightness calculating section configured to calculate, when it has been determined that the adjusting of the optical axis has not been conducted properly, an image brightness indicating a brightness of an image captured at the time of the adjusting of the optical axis; and
an image brightness transmitting section configured to transmit the image brightness to the adjusting device, and
the adjusting device further includes:
an image brightness receiving section configured to receive the image brightness; and
a display section configured to display the image brightness.

12. The optical axis adjusting system for the image capturing device according to claim 11, wherein the image brightness calculating section calculates an average luminance value of an image captured at the time of the adjusting of the optical axis, and calculates the image brightness as a value in accordance with the average luminance value.

13. The optical axis adjusting system for the image capturing device according to claim 11, wherein:
the optical axis adjusting section adjusts the optical axis based on a captured image of a target arranged in a forward direction of the image capturing device in a state where the setting parameter is set to be the adjustment setting value; and
the image brightness calculating section calculates an average luminance value of an image area representing the target within the image captured at the time of the adjusting of the optical axis, and calculates the image brightness as a value in accordance with the average luminance value.

14. The optical axis adjusting system for the image capturing device according to claim 9, wherein the setting parameter at least includes an exposure time for the image capturing device.

15. The optical axis adjusting system for the image capturing device according to claim 9, wherein the setting parameter includes an aperture value for an aperture member that limits an incident light volume of the image capturing device.

16. The optical axis adjusting system for the image capturing device according to claim 9, wherein the optical axis adjusting section adjusts the optical axis based on a captured image of a target arranged in a forward direction of the image capturing device in a state where the setting parameter is set to be the adjustment setting value.

17. An adjusting device included in an optical axis adjusting system for adjusting an optical axis of an image capturing device that is mounted on a vehicle and that captures an image of a periphery of the vehicle, the adjusting device comprising:
a setting value storing section configured to store, in advance, an adjustment setting value that is used as a value of a setting parameter for image-capturing when the adjusting of the optical axis of the image capturing device is conducted; and
a setting value transmitting section configured to transmit the adjustment setting value to the image capturing device.
